(19) United States
(12) Patent Application Publication
(10) Pub. No.: US 2013/0239405 A1
(43) Pub. Date: Sep. 19, 2013

(54) TRACK REMOVER / ASSEMBLER

(71) Applicants: Trevor C. Griffith, Claypool, IN (US); Erich C. Griffith, Warsaw, IN (US)

(72) Inventors: Trevor C. Griffith, Claypool, IN (US); Erich C. Griffith, Warsaw, IN (US)

(21) Appl. No.: 13/837,154

(22) Filed: Mar. 15, 2013

Related U.S. Application Data
(60) Provisional application No. 61/611,613, filed on Mar. 16, 2012.

(51) Int. Cl. B23P 6/00

(52) U.S. Cl. CPC B23P 6/00
USPC 29/700

(57) ABSTRACT

A track replacement apparatus including a lower lifting device and an upper tensioning device coupled to the lower lifting device.

### CROSS REFERENCE TO RELATED APPLICATIONS

This is a non-provisional application based upon U.S. provisional patent application Ser. No. 61/611,613, entitled “TRACK REMOVER/ASSEMBLER”, filed Mar. 16, 2012, which is incorporated herein by reference.

### BACKGROUND OF THE INVENTION

1. Field of the Invention

The present invention relates to track replacement equipment associated with tracked vehicles, and, more particularly, to a track removal/assembly method and system associated with the tracks of the tracked vehicles.

2. Description of the Related Art

A crawler vehicle, such as a skid loader, typically has two endless tracks that serve to support and propel the vehicle. Each track is entrained about a drive sprocket, an idler roller and a series of track rollers. Typically the idler roller is adjustable to thereby alter the tension in the track to enable the track to function in a desired manner. A tensioning mechanism is used to change the position of the idler roller to create the needed tension in the track so that the track is retained on the set of rollers. Wear in the track or stretching of the track creates slack in the track which needs to be removed for continued proper use of the track and this is accomplished by adjusting the tensioning mechanism.

Associated with each track is a drive sprocket that is powered by way of a gearing system that is driven by an engine. The drive sprockets typically have teeth that interact with the track to drive the track. To remove the track a series of tools are used. For example, the vehicle is jacked up, the tensioning system is retracted and a host of pry bars, hammers and hoists are used to remove the track. A reverse process is used to put a track back onto the vehicle.

What is needed in the art is a way of cost effectively removing and replacing the track on a tracked vehicle.

### SUMMARY OF THE INVENTION

The present invention provides an apparatus and method for removing and replacing a track on a tracked vehicle.

The invention in one form is directed to a track replacement apparatus including a lower lifting device and an upper tensioning device coupled to the lower lifting device.

The invention in another form is directed to a track replacement apparatus including a lifting device and a force applying device coupled to the lifting device.

An advantage of the present invention is that it provides support to the bottom of the track and lifts the top of the track.

Another advantage is that the present invention allows the track to be rolled away from or into position on the vehicle.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of a tracked vehicle and an embodiment of a track removal/replacement apparatus according to the present invention;

FIG. 2 is another perspective view of the track removal/replacement apparatus of FIG. 1;

FIG. 3 is yet another perspective view of the track removal/replacement apparatus of FIGS. 1 and 2;

FIG. 4 is a perspective view of another embodiment of a track removal/replacement apparatus of the present invention;

FIG. 5 is a perspective view of yet another embodiment of a track removal/replacement apparatus of the present invention;

FIG. 6 is a perspective view of still another embodiment of a track removal/replacement apparatus of the present invention;

FIG. 7 is a perspective view of the track removal/replacement apparatus of FIG. 6, with a track positioned thereon;

FIG. 8 is a perspective view of the track removal/replacement apparatus of FIGS. 6 and 7; and

FIG. 9 is another perspective view of the track removal/replacement apparatus of FIGS. 6-8, with the track being supported by the apparatus.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

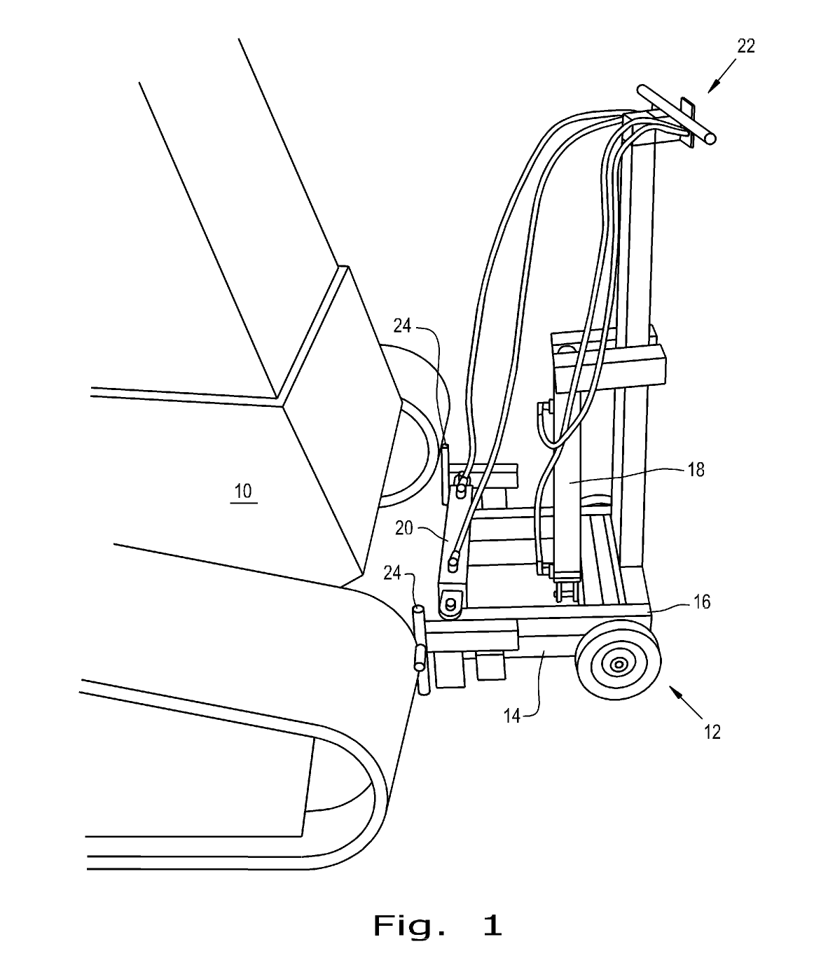

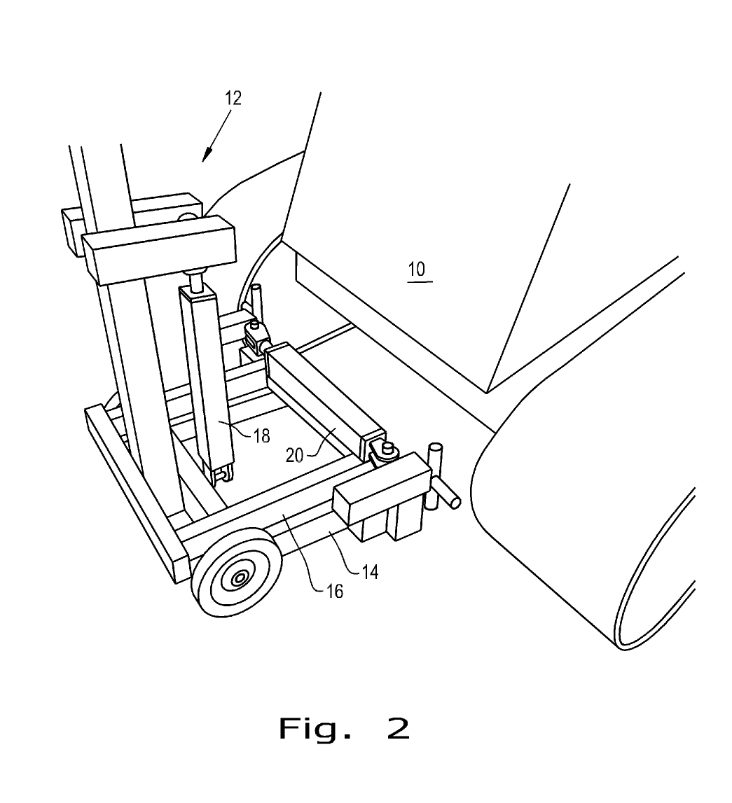

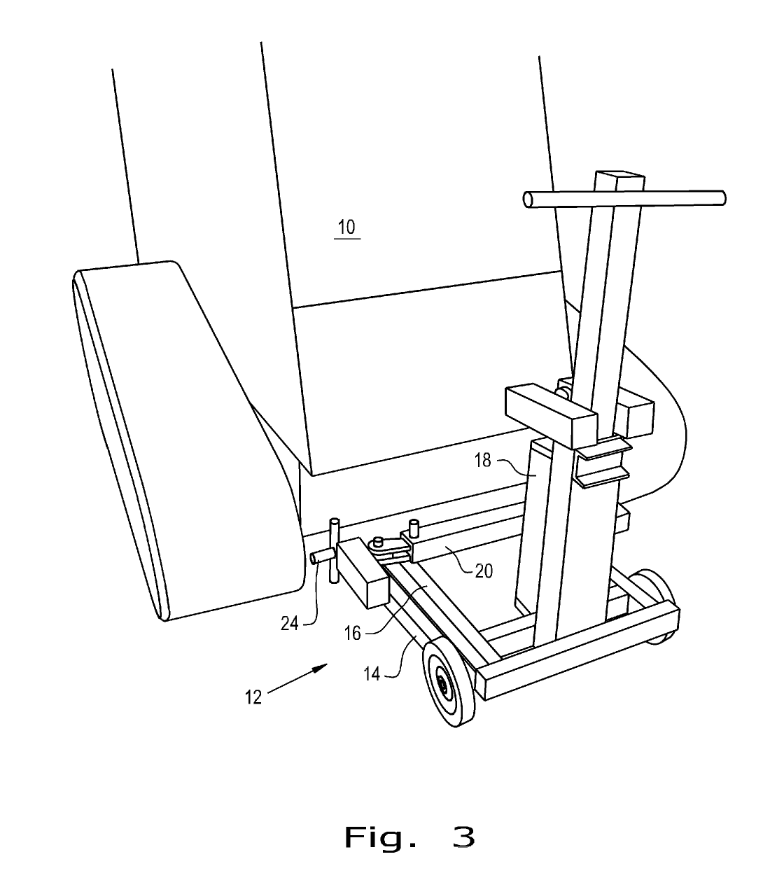

Referring now to the drawings, and more particularly to FIGS. 1-3, there is shown a tracked vehicle 10 having tracks either removed or installed using remover/assembler 12. Remover/assembler 12 includes a floor encountering frame 14, a frame 16, a lift actuator 18, a lateral actuator 20, controls 22, and track engaging extensions 24. Tracked vehicle 10 is elevated using jacks (not shown) and remover assembler 12 is wheeled into place proximate to an end of vehicle 10 so that track engaging extensions 24 are aligned to engage the tracks of vehicle 10. Hydraulic lines are connected to a pressurized hydraulic fluid source, which may be an auxiliary output of vehicle 10 or some other source. Although a hydraulic system is illustrated and referred to herein, other types of systems are also contemplated, such as electrical, pneumatic and steam. Frame 14 contacts the floor and controls 22 are used to position frame 16 so that track engaging extensions 24 will properly engage the tracks as actuator 20 extends track engaging extensions 24.

Although the steps to remove the tracks are discussed herein a substantially reverse set of steps will allow for remover/assembler 12 to assist in the mounting of the tracks on vehicle 10. With the weight of vehicle 10 being removed from the tracks, and tension having been removed by a relaxation of the track tensioners, the action of actuators 18 and 20 are controlingly used to lift the tracks and push them outwardly. This outward movement allows for the removal of the tracks from the tensioners and/or sprockets of vehicle 10. The tracks may be rotated by either running vehicle 10 or using another apparatus to move the tracks to thereby assist in the removal (installation) of the tracks. The tracks may be a synthetic or rubber type of track.

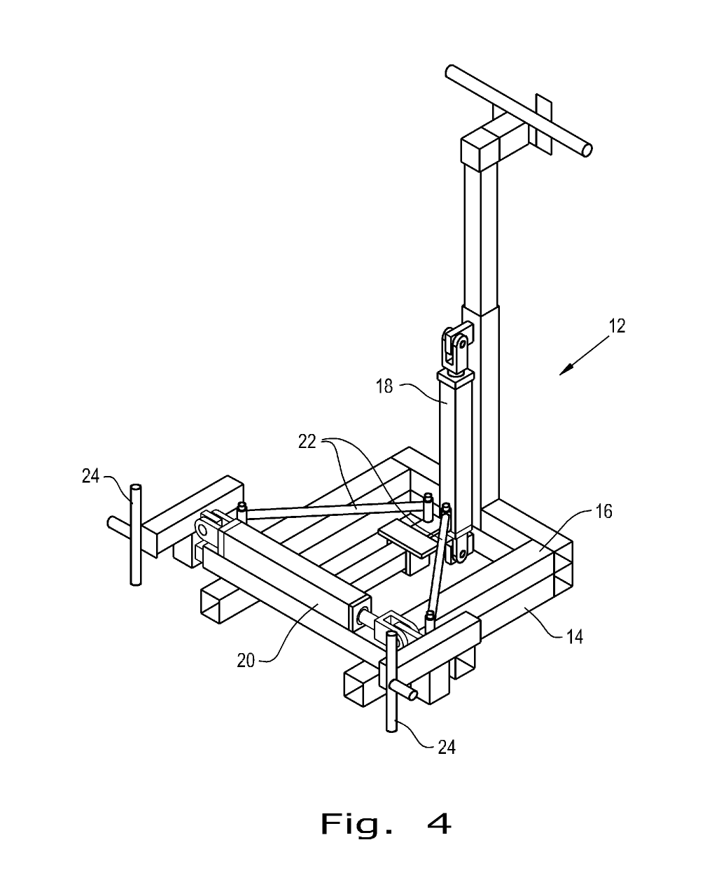

Now, additionally referring to FIG. 4, there is additionally illustrated an equalizing apparatus 26 that may slide along a portion of frame 16 as actuator 20 is actuated. Equalizing apparatus 26 results in a substantially equal movement of the two tracks as actuator 20 extends outwardly.

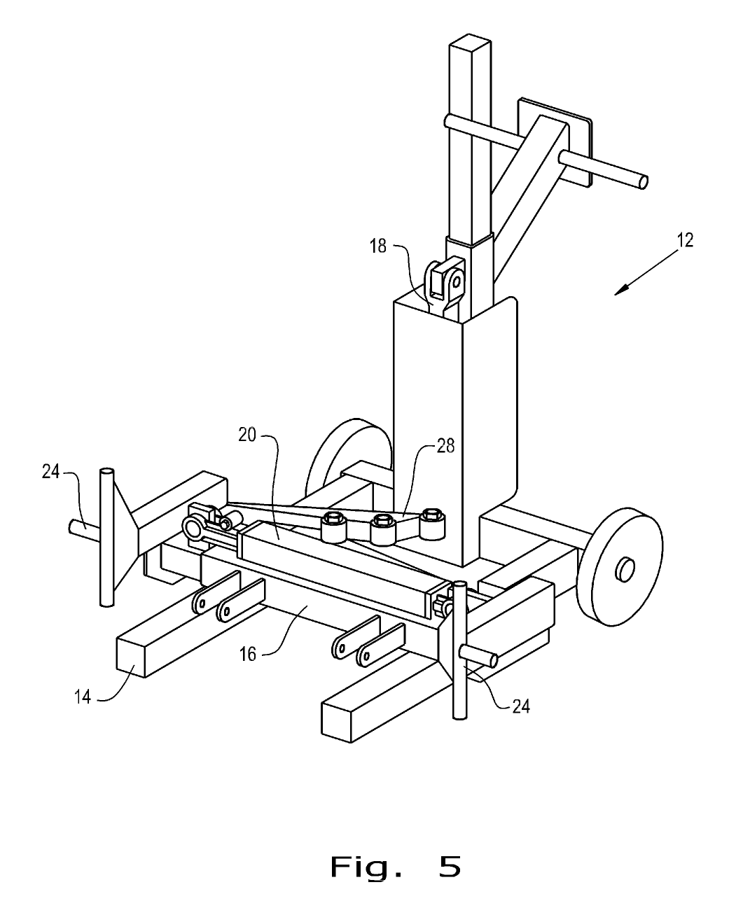

Now, additionally referring to FIG. 5, there is illustrated another embodiment of an equalizing apparatus 28 that cams and rotates as actuator 20 is actuated. Equalizing apparatus 28 results in a substantially equal movement of the two tracks as actuator 20 extends outwardly.

Remover/assembler 12 is easily rolled into position and as the tracks are lifted, frame 14 engages the floor or ground to stabilize the system and allow for a difference in force being applied to the two tracks due to the coaction of frame 14 and equalizing apparatus 26 or 28. Remover/assembler 12 allows for the smooth operation of track removal and assembly as compared to the methods previously utilized. Controls 22 may be manual lever type of controls, or be a pilot set of controls or under electronic control using a touch pad or even voice commands.

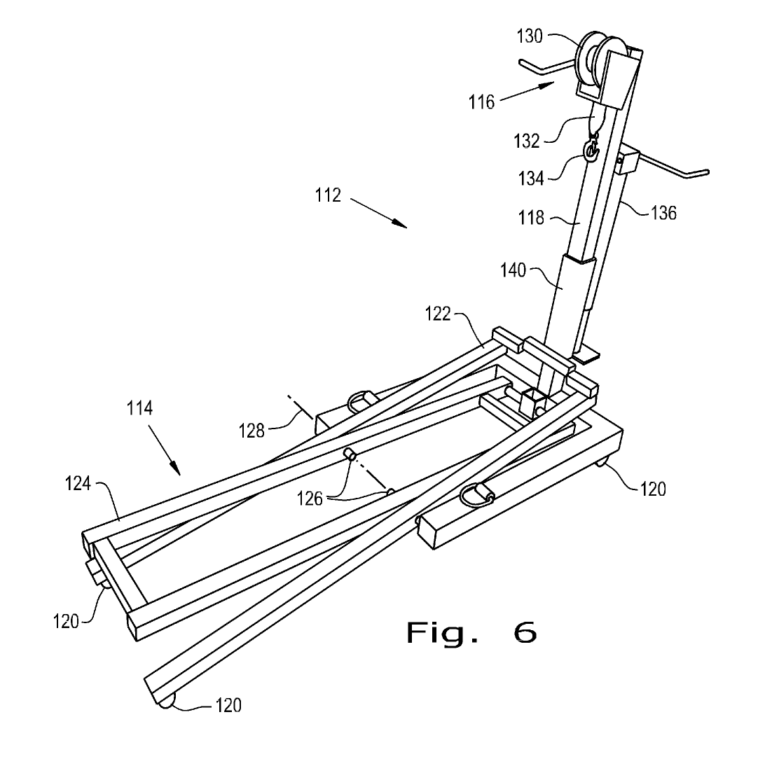

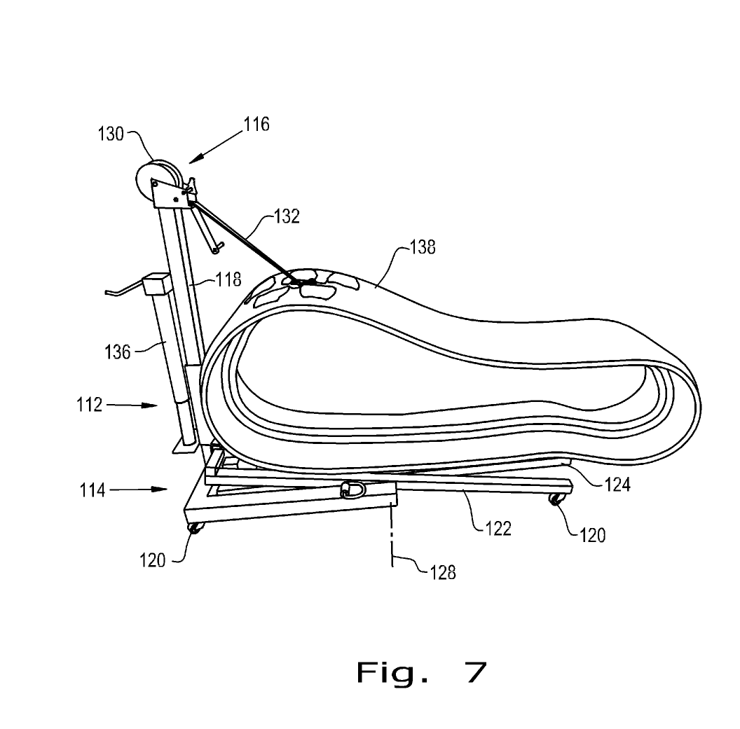

Now, additionally referring to FIGS. 6-9, there is shown another embodiment of the present invention in the form of a track remover/assembler 112. Track remover/assembler 112 includes a lifting device 114, a tensioning device 116, and a structural member 118 coupling the two together. Rollers 120 are connected to lifting device 114 to allow track remover/assembler 112 to be easily positioned during the removal and replacement of a track 138.

Lifting device 114 includes a lifting member 122, a lifting member 124 a pivotal connection 126 and a jack 136. Lifting members 122 and 124 are somewhat complementary and work together as jack 136 is used to move the ends of lifting members 122 and 124, which are proximate structural member 118. Wheels or rollers 120 allow lifting members 122 and 124 to scissor about pivotal connection 126 as the rollers 120 connected to one end of lifting member 122 and rollers 120 connected to an opposite end of lifting member 124 move to accommodate the lifting force imparted to lifting members 122 and 124 by jack 136. Pivotal connections 126 are substantially coaxially aligned with an axis 128. One end of jack 136 is attached to structural member 118 and the other end of jack 136 is connected to a sleeve 140 that slides along structural member 118 and is attached to one end of lifting member 122. Track 138 is cradled and lifted by lifting device 114.

Tensioning device 116 includes a tensioner 130, a web 132 and a track coupling 134. Tensioner 130 has a ratcheting feature to help hold tension on web 132 at a desired level. Web 132 is partially wound around tensioner 130 and extends out to track 138, when coupled thereto. Coupling 134 connects to track 138 to not only lift a portion of track 138, but to pull track 138. Track 138 is generally heavy and stiffly resilient, so the tensioning force applied pulls track 138 back against structural member 118, which coacts to cause the upper part of track 138 to lift upward. The tensioning force has a horizontal and a vertical component, which is dependent upon where coupling 134 is connected to track 138. It is also contemplated that tensioner 130 may be extended or retracted substantially vertically by having that capability associated with structural member 118, to thereby allow a different angle of tension to be applied by web 132 for any given position of coupling 134.

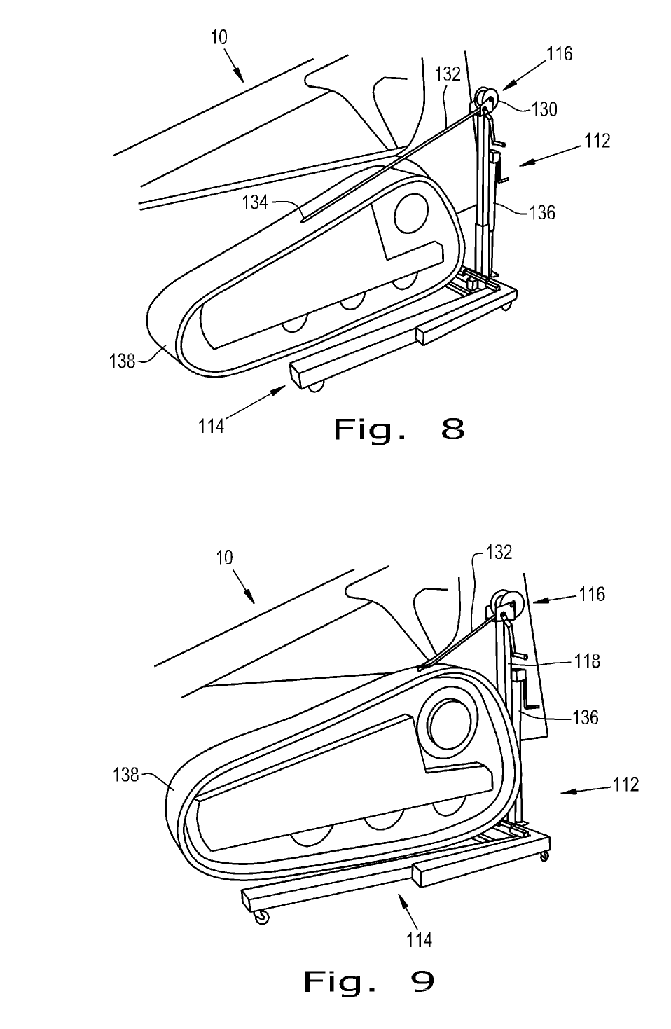

To remove a track 138 form a vehicle 10, vehicle 10 is jacked up using a jack (not shown) and track remover/assembler 112 is rolled into position as shown in FIG. 8. The tensioning features that hold track 138 in an operating tension on vehicle 10 are released to allow slack in track 138. Coupling 134 is coupled to track 138 at a desired location and tensioner 130 is cranked drawing track remover/assembler 112 up against track 138, as shown in FIG. 9 and lifting track 138 so that the teeth of track 138 (omitted here for the sake of clarity) are disengaged from the rollers and drive sprocket. The tension supplied by way of tensioning device 116 may additionally assist in causing the track tensioning device of vehicle 10 to further retract.

The combined adjustment of lifting device 114 and tensioning device 116 as well as the manually positioning of track remover/assembler 112 allow for the positioning of track 138 to clear the rollers and sprockets of vehicle 10 so that track remover/assembler 112 with track 138 is then rolled sideways away from vehicle 10 for the removal of track 138.

To put a new track 138 onto vehicle 10 the above process is reversed and tension is applied by the vehicle track tensioning system to place track 138 into an operation position.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A track replacement apparatus, comprising:
a lower lifting device; and
an upper tensioning device coupled to said lower lifting device.

2. The track replacement apparatus of claim 1, further comprising a structural member coupling said lower lifting device with said upper tensioning device.

3. The track replacement apparatus of claim 2, wherein said lower lifting device includes at least one lifting member and at least one rolling support connected to said lifting member.

4. The track replacement apparatus of claim 3, wherein said at least one lifting member includes a first lifting member and a second lifting member, said first lifting member being pivotally connected to said second lifting member at a pivotal connection.

5. The track replacement apparatus of claim 4, wherein said pivotal connection is proximate to a central portion of both said first lifting member and said second lifting member.

6. The track replacement apparatus of claim 5, wherein said at least one rolling support is a plurality of rolling supports, with a first rolling support coupled to one end of said first lifting support and a second rolling support coupled to one end of said second lifting support.

7. The track replacement apparatus of claim 6, wherein said first rolling support and said second rolling support are respectively positioned proximate to opposite ends of the track replacement apparatus.

8. The track replacement apparatus of claim 1, wherein said tensioning device has a coupling device configured to be coupled to a portion of a track.

9. The track replacement apparatus of claim 8, wherein said tensioning device provides a partially vertical and a partially horizontal tensioning component to the track.

10. The track replacement apparatus of claim 9, wherein said tensioning device is configured to pull on the track while said lifting device supports the track.

11. A track replacement apparatus, comprising:
a lifting device; and
a force applying device coupled to said lifting device.

12. The track replacement apparatus of claim 11, further comprising a structural member coupling said lifting device with said force applying device.

13. The track replacement apparatus of claim 12, wherein said lifting device includes at least one lifting member and at least one rolling support connected to said lifting member.

14. The track replacement apparatus of claim 13, wherein said at least one lifting member includes a first lifting member and a second lifting member, said first lifting member being pivotally connected to said second lifting member at a pivotal connection.

15. The track replacement apparatus of claim 14, wherein said pivotal connection is proximate to a central portion of both said first lifting member and said second lifting member.

16. The track replacement apparatus of claim 15, wherein said at least one rolling support is a plurality of rolling supports, with a first rolling support coupled to one end of said first lifting support and a second rolling support coupled to one end of said second lifting support.

17. The track replacement apparatus of claim 16, wherein said first rolling support and said second rolling support are respectively positioned proximate to opposite ends of the track replacement apparatus.

18. The track replacement apparatus of claim 11, wherein said force applying device has a first engaging device coupled to one end of said force applying device and a second engaging device coupled to an opposite end of said force applying device, said first engaging device being configured to engage a portion of one track, said second engaging device being configured to engage a portion of another track.

19. The track replacement apparatus of claim 18, wherein said force applying device provides a partially vertical and a partially horizontal force component to the tracks.

20. The track replacement apparatus of claim 19, wherein said force applying device is configured to push on the tracks while said lifting device lifts the tracks.
